(19) United States
(12) Patent Application Publication
(10) Pub. No.: US 2014/0301121 A1
(43) Pub. Date: Oct. 9, 2014

(54) Tunneling Electric Contacts And Related Methods, Systems And Applications

(71) Applicant: Anam Nanotechnology, Inc., San Francisco, CA (US)

(72) Inventor: Jaser Abdel Rehem, San Francisco, CA (US)

(73) Assignee: Anam Nanotechnology, Inc., San Francisco, CA (US)

(21) Appl. No.: 14/154,624

(22) Filed: Jan. 14, 2014

Related U.S. Application Data
(60) Provisional application No. 61/957,999, filed on Jul. 17, 2013.
(60) Provisional application No. 61/853,466, filed on Apr. 5, 2013.

(51) Int. Cl. H02M 7/32; H01H 9/54; H01H 1/02; H01H 9/50; H01H 3/00

(52) U.S. Cl. CPC H02M 7/32; H01H 9/50; H01H 3/00; H01H 1/02; H01H 9/54
USPC 363/110; 335/107; 200/502; 307/113

(57) ABSTRACT

This disclosure provides an electrical switch based on tunneling electric contacts. Electrodes of the switch are formed to have reciprocal apparent contact surfaces, each smooth such that a compressed (in contact) composite mean asperity height between these surfaces is significantly smaller than an electron tunneling length of the switch. A movement mechanism is used to physically move one or both electrodes to vary the gap between electrodes to be greater than/less than the electron tunneling length. In select embodiments, the movement mechanism is electrically actuated and is amenable to relatively high frequency operation. The nano smooth surfaces provide for a tunneling switch where current flow is not primarily dependent on contact force between electrodes, and leads to a highly conductive ON state exceeding high performance, high-contact force mechanical switches, while also being amenable to high frequency operation.

This document claims priority to U.S. Provisional Patent Application No. 61/853,466 for “Quantum Tunneling Electric Contacts, Switches And Relays,” having a first named inventor of Jaser Abdel Rehem and filed on or about Apr. 5, 2013, and to U.S. Provisional Patent Application No. 61/957,999 for “Sliding Electrolyte Electric Contacts,” having a first named inventor of Jaser Abdel Rehem and filed on or about Jul. 17, 2013 as provisional application No. 61/957,999. Each of the aforementioned patent applications is hereby incorporated by reference.

### BACKGROUND

Electric switches, especially mechanical switches and semiconductor switches, are important components of all electrical devices. They enable fundamental controls for any electrical system, including for both relatively simple systems such as the control of a light bulb, and relatively intricate systems such as today's digital processing computers. Mechanical switches typically feature two electrodes where one or both electrodes are moved to bring the electrodes into contact (to close the particular switch and permit current flow between the electrodes) and out of contact (to open the particular switch and interrupt current flow between the electrodes). When electrodes are brought together to close a mechanical switch, the actual contact area is much smaller than the apparent contact area, because the conductors are not perfectly flat and make contact only at discrete points. Current flow for a given voltage between those conductors typically occurs only at these discrete points and is proportional to the square root of the amount of force applied between the electrodes; this is because such contacts deforms one or both electrode surfaces as contact spots that increase in size with force and helps overcome any insulating layers which impeded conductivity. Given practical limitations on contact force, mechanical switches have diminishing returns, as they must have appropriate materials and be relatively large to bear the required contact forces; in addition, these switches are degraded through pitting, sparking and other processes, particularly for high voltage applications. Semiconductor switches, by contrast, typically feature two high conductivity regions separated by a low-conductivity region called a channel; the channel is electrically controlled via a “gate” terminal to permit charge to selectively flow between the two high conductivity regions. There are many forms of semiconductor switches, exemplified by field effect transistors (“FETs”), thyristers, and other devices. Semiconductor switches can be made small, be made at low cost, and be made to operate at high frequency, however, they have low conductivity relative to their mechanical counterparts. In addition, semiconductor switches also have relatively high leakage current when in an “OFF” state and they suffer from high electrical noise.

### BRIEF DESCRIPTION OF THE FIGURES

FIG. 1A is an illustrative diagram of a tunneling switch 101, seen in an open state. Movement arrows 107 indicate that the switch is operated by moving electrodes apart and together to change a “gap” between electrodes.

FIG. 1B is an illustrative diagram of the tunneling switch of FIG. 1A, now seen in a closed state. Because the gap between electrodes has been reduced to less than the electron tunneling length (“length”), tunneling current now flows between electrodes as depicted by flow arrows 118.

FIG. 2 is a flow chart showing methodologies associated with the tunneling switch of FIGS. 1A and 1B, with dashed line boxes indicating various optional features.

FIG. 3 is an illustrative diagram of another tunneling switch 301.

FIG. 4 is an illustrative diagram showing two electrodes 403 and 405 that are brought together and drawn apart to close and open a tunneling switch. As depicted by a magnified view of a portion of current crossing region 411, in some embodiments, the electrodes 403 and 405 are fabricated with controls over asperities and/or surface roughness, helping to bring more electrode surface area within tunneling distance.

FIG. 5 shows a graph 501 of conductivity of a tunneling switch, such as the switches of FIGS. 1A-B, FIG. 3 or FIG. 4, as a function of gap between electrodes.

FIG. 6 shows a graph 601 of conductivity as a function of contact pressure between electrodes in a tunneling switch. Unlike a conventional mechanical switch, the conductivity of a tunneling switch when closed after initial compression is substantially independent of contact force between electrodes and has substantial positive conductivity, even with near-zero contact pressure.

FIG. 7 is a flow chart relating to a tunneling switch.

FIG. 8 is a schematic of a pulse width modulation device 801 predicated on a tunneling switch.

FIG. 9A is a schematic of a power switching device 901 based on multiple tunneling switches connected in series. This type of connection is amenable to high voltage applications, for example, where a voltage to be switched on and off is higher than the “breakdown voltage” of any one tunneling switch.

FIG. 9B is an illustrative diagram that shows a compound tunneling switch; such a switch can be used, for example, to form the multiple tunneling switches of FIG. 9A.

FIG. 10 is a schematic of another power switching device 1001 that is structured for high availability operation. That is, two or more tunneling switches are connected in parallel sets or cells (e.g., cell 1013), such that the power switching device 1001 can be maintained in a conducting state if any one tunneling switch is taken off-line.

FIG. 11 is a schematic of an AC (alternating current)-to DC (direct current)-power converter 1101 predicated on at least one tunneling switch. More specifically, FIG. 11 shows a “full wave rectifier” formed from tunneling switch pairs 1103 and 1105.

FIG. 12 is a schematic of a DC-to-AC power converter 1201 predicated on at least one tunneling switch. More specifically, FIG. 12 shows a power inverter that converts a DC power source (depicted by battery symbol 1207) into an AC output, at nodes 1211 and 1215.

FIG. 13A shows a six-step AC-to-DC power converter 1301 that converts three phases of AC input (seen in the FIG. as “AC₁,” “AC₂” and “AC₃”) into a DC output.

FIG. 13B shows a timing diagram 1351 illustrating the generation and application of control pulses “A,” “B,” “C,” “D,” “E” and “F” to operate the six-step power converter of FIG. 13A.

The subject matter defined by the enumerated claims may be better understood by referring to the following detailed description, which should be read in conjunction with the accompanying drawings. This description of one or more particular embodiments, set out below to enable one to build and use various implementations of the technology set forth by the claims, is not intended to limit the enumerated claims, but to exemplify their application. Without limiting the foregoing, this disclosure provides several different examples of a tunneling switch, a method of operation based on the principles of a tunneling switch, methods of manufacture of a tunneling switch, and power circuit implementations based on such a switch. While specific examples are presented, the principles described herein may also be applied to other methods, devices and systems as well.

### DETAILED DESCRIPTION

This disclosure provides a switch having two electrodes where one or both electrodes are physically moved to open and close the switch. The electrode apparent contact surfaces are fabricated to have smoothness and parallelism when in contact, such that closure of the switch consistently reduces a gap between these surfaces across their substantial entirety to be less than the electron tunneling length of the switch; this closure permits tunneling current to flow. Switch conductivity therefore becomes a function of surface area of the electrode apparent contact surfaces and gap separation between these surfaces, and is not primarily dependent on high physical contact force between these surfaces. A movement mechanism is used to selectively close the switch by bringing the apparent contact surfaces to within tunneling distance, and to open the switch by increasing the gap to be greater than the electron tunneling distance. In one implementation, the movement mechanism can be an electronic actuator capable of relatively high-frequency and repeatable control, such as a piezoelectric, electrostatic or electromagnetic actuator. A tunneling switch founded on some or all of these principles provides conductivity exceeding that of traditional mechanical switches, while also providing a wide frequency range of operation, low electrical noise, long service life, and low to nonexistent leakage current. As should therefore be appreciated, the techniques provided by this disclosure facilitate a novel design of electrical switches with wide ranging application.

A tunneling, non-adhering apparent contact surface for each electrode can be formed as a “nano smooth” surface with low free surface energy. For tunneling current to flow effectively using the entire surface area for each electrode's apparent contact surface, mean asperity height for each such surface is effectively limited, such that asperities are small and/or have only gradual slopes; the substantial entirety of these surface areas can thus be brought sufficiently close to one another for tunneling current to flow using the substantial entirety of those surface areas, e.g., even with presence of a thin insulator between them. Optionally, one or both of the apparent contact surface areas can be made relatively thin and be backed with a material that permits contact area deformation, permitting (in concert with regulated mean asperity height) effective low-force gap control over the apparent contact surfaces. In addition, these surfaces can also be selected/fabricated such that their free surface energy is sufficiently low to prevent cold welding or excessive adhesion. In such circumstances, high conductivity, non-adhering, thermally insulating, low contact force, electric contacts can be created.

Note that as used herein, the terms “apparent contact surface,” “contact surface,” current-crossing surface,” “engagement surface,” “contact area” and similar terms will be used interchangeably in the context of a tunneling switch. Despite presence of the word “contact,” it should be generally understood that actual contact between electrodes is not strictly required for current to flow as long as one electrode is brought to within tunneling distance of the other electrode. What these various terms refer to is that with each electrode, there is typically an engagement surface through which it is intended that current will flow from one electrode to the other electrode when a switch is closed; with a tunneling contact switch, by structuring the electrodes in a manner where their apparent contact surfaces can be made sufficiently smooth, and or conformably-deformed, such that the mean separation between the apparent contact surfaces when the switch is turned ON can be reduced to less than tunneling length of the switch, current flows between widespread regions of these apparent surfaces, and not only at spot contact points. There may be asperities or irregularities that prevent actual contact from occurring in certain regions of such an electrode surface within this contact, but the term “contact” or “engagement” is still used to refer to the intent that tunneling current flow through such regions due to an electrode gap separation less than the electron tunneling length of the switch.

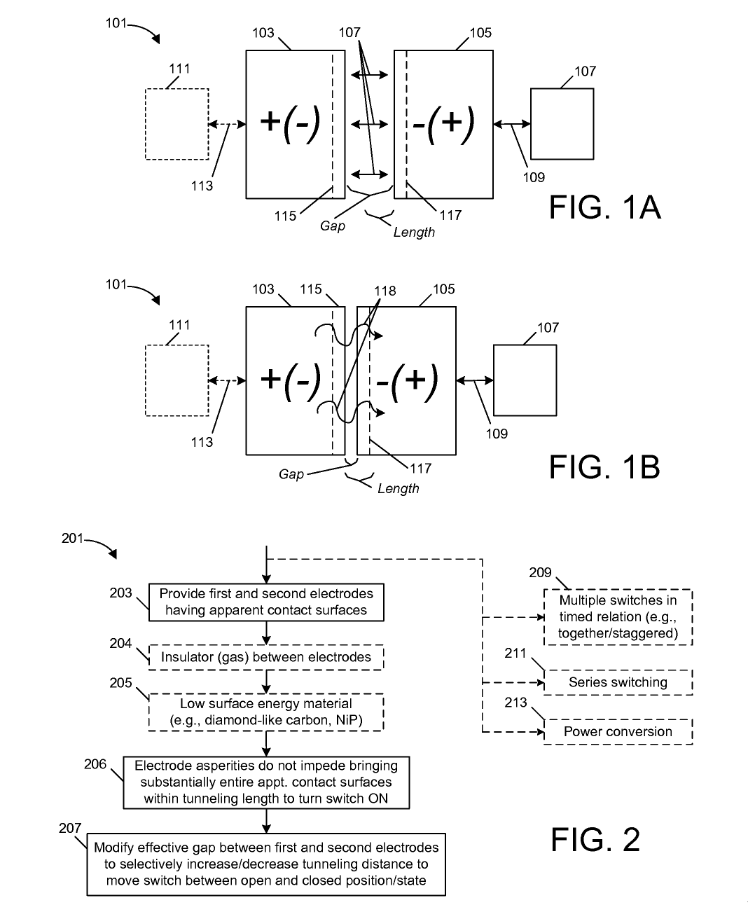

FIGS. 1A and 1B provide a first example of a tunneling switch 101. FIG. 1A is used both to introduce the switch and to show the switch in an “open” (or non-conducting or “OFF” state or position), while FIG. 1B is used to show the switch in a “closed” (e.g., a conducting state or ON state or position). First referring to FIG. 1A, the switch 101 is seen to possess two electrodes 103 and 105. As denoted by dimensional arrows 107, the switch is controlled in a manner that brings an apparent contact surface (or current-crossing surface) of one electrode into or out of proximity of a reciprocal surface of the other electrode. Note once again that actual contact between these contact surfaces is not strictly required for current to flow as long as the engagement area of one electrode is brought to within tunneling distance of the engagement area of the other electrode.

The switch is turned ON by physically displacing one or both of these surfaces 115 and 117 of the respective electrodes to close to within this tunneling distance (relative to the other electrode apparent contact surface) and, conversely, is turned OFF by separating the two engagement surfaces by more than this distance. Note that while surfaces 115 and 117 are depicted as substantially planar, nearly any electrode and/or surface structure can be applied; for example, these surfaces can be made curved, interlocking, coaxial, reciprocating, deformable and so forth, as long as the electrodes come together in a manner where apparent area of engagement and gap separation, and not spot contact force between surfaces, are the primary factors governing current flow. FIG. 1A illustrates two distances, respectively referred to as “Gap” and “Length.” The term “Gap” is used to refer to the distance between the apparent contact surfaces of the two electrodes 103 and 105, while the term “Length” refers to the electron tunneling length associated with the switch (i.e., given materials properties of electrodes and any insulator separating the two electrodes). When the gap is greater than the length, substantially no current flow occurs. This is depicted in FIG. 1A, where the switch is seen to be in the OFF position. When the gap between the electrodes becomes is less than the tunneling length (“Length”) electron tunneling occurs substantially over the entire apparent contact surface areas of the respective electrodes, i.e., current flows in a manner not primarily dependent on degree of contact force. What this means is that switch conductivity is largely dependent on other terms (e.g., surface area of the apparent contact surfaces and gap separation) and that a term rooted in the square root of applied force between electrode points already in contact is not the primary factor (e.g. there are other, more important factors contributing to conductivity).

A few additional, optional points should be noted about the structure seen in FIG. 1A.

First, in many embodiments, the gap is structured so as to be highly consistent between apparent contact surfaces as they are brought together. What this means is that in these embodiments, the apparent contact surfaces of the electrodes are structured such that as they come to within tunneling distance of one another, the surfaces either are or become parallel, such that tunneling conductivity is consistent across their substantial entirety. This does not imply that electrode movement has to be linear as the switch is moved between opened and closed positions, e.g., it is possible to have pivoting or other throws to open and close the switch.

Second, while in practice one electrode can be physically moved to open and close the switch (e.g., electrode 105, displaced by movement mechanism 107, as indicated by motion arrow 109), both electrodes can also be moved, as denoted by optional second movement mechanism 111 and motion arrow 113.

Third, while direct physical contact between electrodes is not strictly necessary for tunneling current to flow, in many embodiments, such contact (e.g., at low pressure) is nevertheless utilized to ensure sufficiently small mean gap size across the substantial entirety of the apparent contact surfaces. In addition, a physical throw distance of the switch is advantageously made significantly larger than the tunneling length. Otherwise stated, rather than precisely controlling mechanical throw distance between electrodes with nanometer precision, many embodiments deliberately use an “oversized” throw distance, i.e., on the order of micron size or greater, to open and close the tunneling switch. Relative to the closed state of the switch, providing for electrode contact between apparent contact surfaces helps maximize conductivity between those surfaces (which is otherwise primarily dependent on gap separation), and helps maximize the surface area over which current flows, for example, conforming the respective electrode surfaces to close to within tunneling distance over the substantial entirety of the apparent contact surfaces, in a manner that conforms these surfaces notwithstanding any asperities. Relative to the OFF state of the switch, the minimum throw distance is selected to minimize OFF state field emissions; in practice, a typical throw distance will be selected to be much greater than this minimum distance to ensure no current flows and reliable operation across manufacturing lots. It is noted in this regard that the maximum voltage a tunneling switch can support, before electrostatic breakdown, is typically determined by the breakdown voltage of the medium filling the OFF state gap between contacts. Paschen's law is generally accurate at describing breakdown voltage at different distances. However for gap sizes less than a few microns, electric current due to field emissions becomes significant and Paschen's law, while accurately describing the voltage at which sparking occurs, fails to predict the voltage at which current flows. For tunneling electric contacts and switches it is desirable to maximize the OFF state voltage, eliminate the possibility of damage due to sparking, and eliminate unintended electrostatic breakdown. This can be achieved by selecting the OFF state gap size such that the breakdown electric field predicted by Paschen's law is greater than the electric field across the gap and the field at which significant field emissions occur. For example, Paschen's law predicts a breakdown voltage of air at a 4 micron gap and 1 atmosphere of pressure of the air to be approximately 400 Volts (V). For a voltage difference between electrodes under these circumstances of separation, field emission current flow is approximately zero until a voltage difference of 300 V, at which point current flow grows exponentially. For a tunneling switch having air at one atmosphere of pressure and otherwise meeting these criteria, using the switch in application with a maximum voltage difference of 300V helps minimize or eliminate any current flow with the switch is in the OFF state. In several embodiments, use of a specific gap material between electrodes (for example, using a controlled environment consisting of a “fluid” insulator, such as an appropriate gas or a liquid at an appropriate pressure) helps dramatically increase the breakdown voltage. For example, carbondioflouridedichloride (CF₂CL₂, also known as dichlorodifluoromethane) has a breakdown voltage that at 6 atmospheres of pressure is approximately 17 times that of air; hence by increasing the throw size to continue to avoid significant field emissions the same switch can be used with voltages as high as 5100 V in the presence of such an insulator gas. Using such an insulator therefore substantially increases the operating voltage with which these switches can be used, and helps facilitate high voltage switching applications. Note that, as used herein, an “uncontrolled” atmospheric environment will be used to refer to air at approximately one atmosphere of pressure, whereas a “controlled” atmospheric environment is an environment where an ambient medium other than air is used (e.g., a specific liquid or gas) and/or where pressure maybe something different than the pressure of air at sea level.

As noted above and as indicated by optional block 205, adherence between surfaces can be suppressed through the use of an electrode contact surface material or layer having a low free surface energy. In one embodiment, the electrode apparent contact surface (such as depicted by numerals 115 and 117 in FIGS. 1A and 1B) can optionally be made a different material than the bulk of the electrode; for example, electrodes 103 and 105 from FIGS. 1A and 1B could be made of a conductor (e.g., copper) while the flow surfaces 115 and 117 could be a thin layer of a low surface energy amorphous material such as semi-conducting diamond-like carbon or high phosphorus electroless nickel (NiP) or electroless nickel boron (NiB). Other materials are also possible.

In the design represented by FIGS. 1A and 1B, any electrically-insulating layer (e.g. native oxides, and/or other forms of surface termination such as hydroxide molecules or hydrogen atoms) separating the electrode contact surfaces is made sufficiently thin to allow tunneling current to flow when the switch is in the ON position. In contemplated designs, any permanent such layer is restricted to be less than 1 nanometer, with thinner layers providing for substantially higher tunneling conductivities. In one embodiment, therefore, a switch is advantageously constructed by using materials with naturally thin native oxide layers to form the apparent contact surfaces, e.g. Nickel, and/or materials where the native oxide can be removed and be kept off in sealed packaging. Nickel-Boron (NiB) provides one suitable example.

As mentioned, the tunneling switches use electrode apparent contact or current-crossing surfaces that are “nano smooth.” This helps facilitate electric contacts where their apparent contact surfaces can consistently be brought to within electron tunneling length of one another across their substantial surface areas. In one embodiment, the electrode mean roughness (root means square, or RMS) is configured to be 10 nanometers or less to permit this to occur; in other embodiments, as supported by polishing or fabrication technology, this mean roughness is made still smaller (e.g., less than 5 Angstroms). Note again that for many embodiments application of significant contact force (e.g., more than about 20 Newtons) is not required between electrodes to provide significant current flow. That is, many embodiments provide a switch having conductivity exceeding 10⁴ Siemens per square centimeter (cm²) at an electrode contact force less than about 20 Newtons.

Finally, another advantage of the depicted structure, not shared by all semiconductor switches, is that the tunneling switch has no dominant or required polarity; this is represented by reciprocal “+(−)” and “−(+)” depictions on the respective electrodes 103 and 105. That is, some semiconductor switches require that current flow in one direction only. However, with the design depicted in FIG. 1A, both electrodes can be made of the same conductive material, and thus, operation can be made independent of any particular current flow direction. Further advantages and options will become clear from the description below.

FIG. 1B as mentioned shows the switch 101 of FIG. 1A in a closed or ON position. This FIG. represents the same switch as depicted in FIG. 1A and therefore uses the same reference numerals to refer to the same components. As seen in this FIG., however, the gap (“Gap”) between apparent contact surfaces 113 and 115 is now smaller than the electron tunneling length (“Length”); consequently, current flows as depicted by electron flow arrows 118. Note that, although not required for many or all embodiments, current flow in FIG. 1B is seen as occurring notwithstanding that the electrodes are not in contact; all that is required is that the electrode apparent contact surfaces are brought (on a consistent basis across their respective surface areas) sufficiently close enough for tunneling current flow to occur. In embodiments presented below, this is facilitated by using electrode apparent contact surfaces for which attention has been devoted to ensuring that these surfaces are smooth and/or are deformable so that they can be brought together in this manner. Thus, rather than having current flow primarily determined by number of contact points and associated “spot radii” where contact force is concentrated between electrodes, current flow is instead primarily determined by the electrode apparent contact surface area within tunneling distance of the other electrode's apparent contact surface area, and the mean gap size between those areas.

FIG. 2 provides a method flow diagram 201 showing steps or processes of controlling a switch in accordance with these principles. Generally speaking, dashed-line boxes indicate method or process options. As indicated by method block 203, one first provides first and second electrodes having apparent contact surfaces. These surfaces each typically comprise a surface that is to be brought into contact with, or to within very close proximity to, an apparent contact surface of the other electrode, with the intent that current flow between their substantial surface areas; in FIGS. 1A and 1B, these areas are represented by surfaces 115 and 117. Note the optional presence of a controlled (insulator) environment between electrodes, as represented by numeral 204, to increase the breakdown voltage of the tunneling switch.

In the embodiment of FIG. 2, note that process block calls for regulating electrode combined mean asperity height in a manner that permits the substantial entirety of the current-crossing surfaces to conform to each other within tunneling length of the switch. In one embodiment, this objective is achieved by providing for a mechanism that permits asperities to compress when in contact. In another embodiment, the electrode surfaces are polished and backed by a flexible substrate. This permits the electrodes' surfaces to conform to each other. In one example, in order to help achieve these criteria, the mean asperity height during contact is restricted to be in nanometer range, or smaller. This can be achieved using an electrode fabrication process that ensures smooth electrode surfaces, for example, such as a chemical deposition process. In another embodiment, this is implemented using a polishing step, either chemical and/or mechanical, to reduce asperity size of already-fabricated electrodes and so produce the nano smooth characteristics alluded to above. In one variation, asperity height is taken to mean absolute asperity height, e.g., very localized electrode asperities are regulated to be no more than one-half the tunneling length predicted for the fluid (gas or liquid) filling the gap between electrode surfaces. As an example, if predicted the tunneling length is 1 nanometer, the maximum local asperity height might be restricted to avoid local variations or more than 5 Angstroms RMS. In still another implementation, composite mean asperity height is restricted to specific criteria, such as according to the equation

σₘₑₐₙ=\sqrt{σ₁²+σ₂²}<<L,

where σₘₑₐₙ represents the mean composite asperity height, σ₁ represents surface roughness of the first electrode's apparent contact surface, σ₂ represents surface roughness of the second electrode's apparent contact surface, and L represents the electron tunneling distance. Irrespective of the criteria used to regulate asperity height, proper switch operation can be tested post-manufacture to determine whether each fabricated component is within any required specification.

Finally, as indicated by numeral 207, the effective gap size between the apparent contact crossing surfaces of the electrodes is changed to open and close the switch. As mentioned, the mechanism used to move one or both electrodes and the throw distance can be selected so as to ensure that there is no tunneling current flow when the switch is in the open position, and such that nano smooth conductor surfaces provide current to flow over the substantial surface areas of the apparent contact surfaces when the switch is moved to the closed position.

As mentioned earlier, the tunneling switch represented by this disclosure can optionally be used in a number of exemplary applications, including where low frequency, high frequency, or dynamically-varying frequency of operation is expected. Numerals 209, 211 and 213 of FIG. 2 refer to several optional implementations. First, per numeral 209, multiple switches can be operated together in timed relation or at related times; by this reference, “it is meant that the switches can be operated together or in a manner that is time-staggered or somehow derived from a common timing relation or timing signal. For example, in a power switching application (e.g., where both high and low voltage rails are to be simultaneously switched), a tunneling switch could be used for each voltage rail, with both switches being opened and closed at the same time. Alternatively, in an AC-to-DC (alternating current to direct current) power conversion application, e.g., a 3-phase power application such as depicted by FIGS. 13A and 13B, different switches could be closed at the same frequency at respective, time-staggered intervals (e.g., at different phases and/or for different periods or duty cycles). In still other variations, the relative ON and/or OFF times can be at respective frequencies. Many such applications are possible. As referenced by numerals 211 and 213, multiple switch applications can feature individual switches operated in series (for example, to spread voltage drops associated with regulating high-voltage across multiple switches) or in parallel (e.g., for high-availability or other purposes). These and other configurations are discussed below.

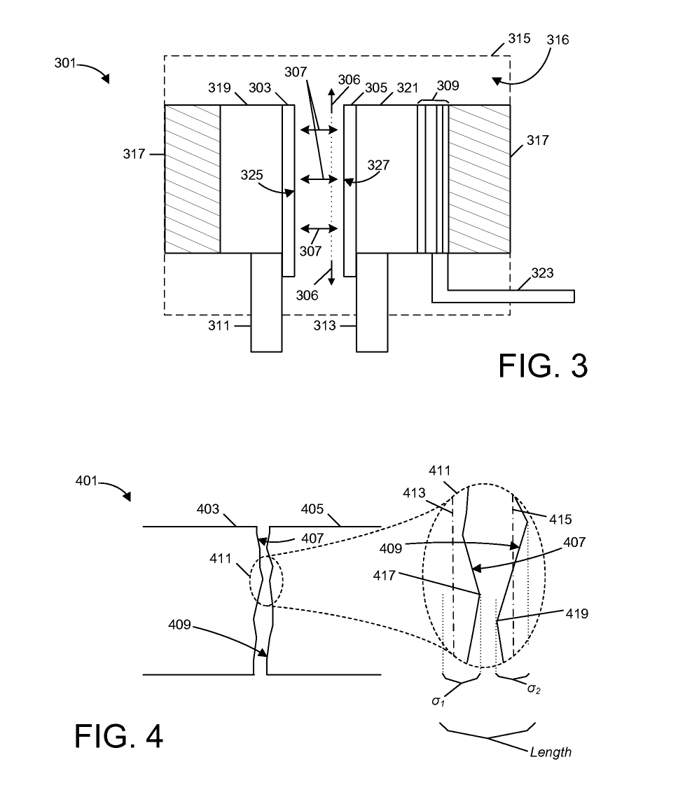

FIG. 3 illustrates another example of a tunneling switch 301. As with the previous examples, this switch includes a first electrode 303 and a second electrode 305 that are to be moved toward and away from each other, as denoted by movement arrows 307. In this example, each electrode has a respective surface, 325 and 327, that has been specially fabricated or processed to be “nano smooth,” and made from or layered with a low free surface energy material. Each surface is also seen to be substantially planar along a direction indicated by arrows 306, with the throw of the switch being normal to each depicted plane. Note again that these features are not required for all embodiments, e.g., the electrode surfaces may be curved in profile, multifaceted, or configured in some other manner, and the throw direction of the switch does not have to be normal to the electrode surface. In the depicted case, the movement mechanism 309 can be implemented as a piezoelectric device that includes one or more electrode layers and one or more piezoelectric material layers that deform under the application of an electric field. As is well-known, piezoelectrics provide a reliable means of cycling small throw-distance movement at frequencies ranging from DC to ultrasonic. Other forms of electromechanical actuators can be used, for example, electrostatic or electromagnetic actuators. The provision of one or more voltage control paths for this electromechanical actuator is represented by pathway 323; in one embodiment, only a single control pathway is provided, for example, in an application where conductor 305 represents a voltage reference such as ground. In another embodiment, pathway 323 represents multiple control paths, for example, relating for ground as well as a control voltage used to activate the piezoelectric layer. The tunneling switch 301 is fabricated such that the electrodes are positioned in a manner where selective activation and deactivation of the piezoelectric material brings the electrodes to less separation than the tunneling length of electrons in the gap material (316) and to provide greater separation than this length, respectively. Each electrode is seen to have a current flow path for current supply to and flow through the electrodes, for example, depicted by paths 311 and 313. Each path can be made of a conductor suitable for the application.

FIG. 3 also depicts optional implementation of the tunneling switch in an enclosure chamber 315, that is, where a controlled atmosphere or a vacuum within the enclosure chamber is used as the gap material 316. Use of the chamber permits the liquid or gas fluid to be displaced as the switch is opened and closed. As mentioned previously, the use of a gap material and/or materials which are insulators relative to air at ambient atmospheric pressure permit a given switch design to be operated at potentially much higher switching voltages than might otherwise be the case, as the breakdown voltage is increased. As referenced earlier, in one contemplated design, a tunneling switch can be structured to have a breakdown voltage on the order of thousands of volts (e.g., >1000V, 3000V, 5000V, etc.). By arranging multiple such switches in series and operating the switches exactly together, an aggregated switch mechanism can be fabricated for very high voltage applications, e.g., 10 kV or higher. The use of a controlled atmosphere as the gap medium facilitates this end with a reduced number of tunneling switches.

In the embodiment of FIG. 3, each electrode 303 and 305 is mounted to a compressible substrate material 319 and 321, respectively, to facilitate conformal contact between intended electrode current-crossing surfaces (325 and 327, respectively). That is, as was mentioned earlier, reliable closure of the switch is motivated by bringing electrode surfaces into low-force contact which, given the smoothness of the electrode current-crossing surfaces 325/327 (e.g., regulated asperity height) ensures that tunneling current flow will dominate relative to force applied at contact points between electrodes. For situations where electrode surfaces are not precisely aligned, or where a statistical metric is applied to surface roughness (e.g., mean asperity height RMS), the conformal substrate permits deformation of the electrode faces (i.e., apparent contact surfaces) to facilitate alignment or deformation of those surfaces after initial fabrication to provide conformance, such that mean gap size in the ON position is smaller than the tunneling length between those surfaces. In one embodiment, the conformal substrate can be made conductive and combined with the main body of the electrode, e.g., so as to permit the body of each electrode (and its nano smooth current-crossing surface) to conform to the shape of the other electrode. Finally, in FIG. 3, a chassis material 317 is seen to provide an anchor for each electrode; that is to say, in the depicted embodiment, electrode 303 is mounted to the chassis 317 through the conformal substrate 319, and electrode 305 is mounted to the chassis 317 through its conformal substrate 321 and the movement mechanism 309.

FIG. 4 is a diagram showing a close-up view of a tunneling switch 401 having first and second electrodes 403 and 405. More specifically, a first of these electrodes is seen to have a current-crossing surface 407 with surface roughness, that is, with asperities that rise above a mean surface of the electrode, and similarly, the second of these electrodes also is seen to have a current-crossing surface 409 with analogous surface roughness. A portion of these electrodes enclosed by ellipse 411 is shown in magnified detail at the right side of FIG. 4. Note that in the FIG. the depiction of asperity height has been exaggerated for purposes of discussion and that the depicted asperities are not true to scale; the depicted electrodes should be assumed to be “nano smooth” in accordance with the principles described earlier, that is, where the combined mean asperity height when in contact is less than the tunneling length of electrons traveling between the electrodes 403 and 405.

As seen in the enlarged view at the right side of the FIG., each side has a mean or average surface, represented by a plane and designated for each electrode by numerals 413 and 415, respectively. Asperities which rise above that surface are referenced by numerals 417 and 419. Each electrode will also have roughness measures associated with their various asperities, such as “σ₁” in the case of asperities of the first electrode 403 and “σ₂” in the case of asperities of the second electrode 405. Note that while mean asperity heights are used to measure for the respective surface, in fact, any height measure could be used which provides a measure relating to permitting conformal contact between electrodes; in practice, given the use of mechanical and/or chemical smoothing processes applied to ensure low mean asperity height, even asperities that exceed the mean height will occupy relatively large surface area, i.e., such that these asperities do not provide a substantial impediment to conformal contact between the electrodes' engagement surfaces. In one embodiment as mentioned, the height (σ) is a mean asperity height RMS (root mean square), relative to the mean surface. As earlier-stated, each electrode is preferably fabricated in a manner that ensures compliance with a specification parameter, for example, that the mean asperity height be less than 5 Angstroms. Other measures are possible, with the end that the mean electrode surfaces (e.g., planes represented by numerals 417 and 419) can be brought to within tunneling distance of one another over significant portions of their surface area, to permit tunneling current flow. In this event, current will flow as a function of intended electrode current-crossing surface area and the gap between them, and not as a primary function of contact force applied between contact points of electrodes. Once again, in practice, some contact force is advantageously applied between electrodes for a tunneling switch, e.g., to ensure that current-crossing surfaces are reliably brought within tunneling distance in a manner that maximizes conductivity and conformal contact between current-crossing surfaces. Note that FIG. 4 depicts the tunneling switch 401 in an ON state, i.e., because the apparent contact surfaces 407 and 409 have a proximity to one another consistently less than the tunneling length (“Length”), and because local asperity height does not significantly impede ability to move the electrode current-crossing surfaces to within this distance.

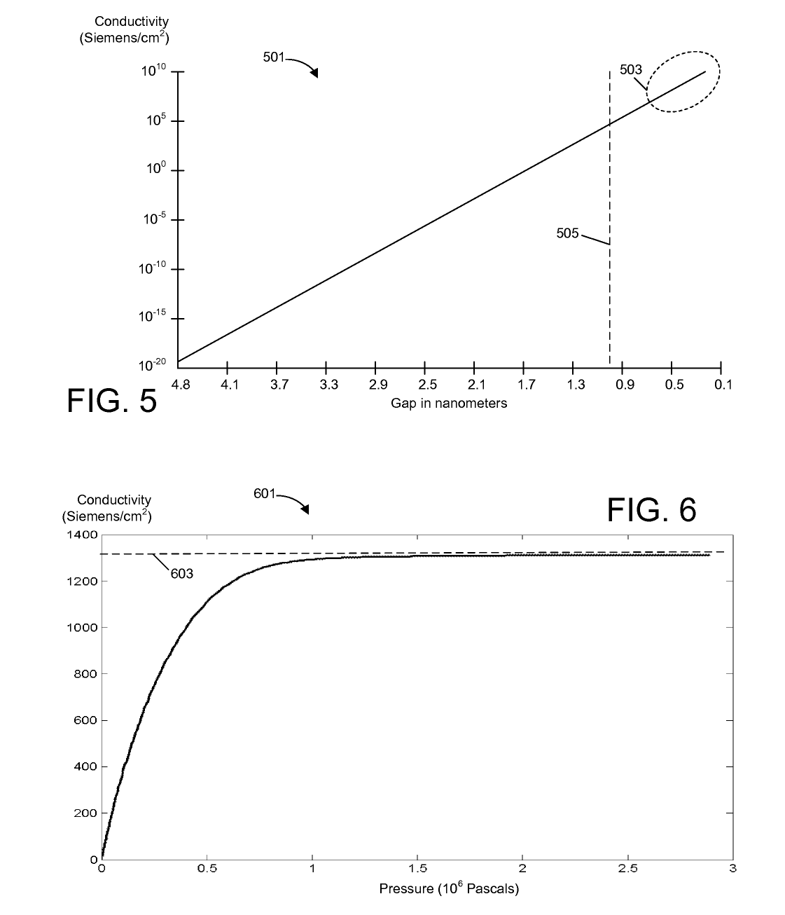

As demonstrated by FIG. 5, conductivity changes for the tunneling switch during mechanical displacement of one or both electrodes to open and close the gap between them. FIG. 5 shows a graph 501 of conductivity between electrodes as a function of gap size in nanometers, assuming an electrode work function of 3 electron volts (3 eV) and a vacuum gap. As depicted, when the gap between apparent contact surfaces (e.g., surfaces 407 and 409 from FIG. 4) changes from approximately 5 nanometers to less than 1 nanometer, the conductivity between the electrodes increases from 10⁻²⁰ Siemens per square centimeter (cm²) to better than 100k Siemens/cm². A throw distance of more than 5 nanometers is thus sufficient for the tunneling switch to be in a non-conductive or OFF state. These numbers can be improved further depending on electrode work function and other factors. Note again that in many embodiments, the “oversized” throw distance of the switch will be significantly greater than the 4.8 nanometer range represented by FIG. 5; that is to say, to ensure mechanical throw sufficient to move electrode separate across the effectively tunneling length, the typical throw will be in the range of microns or more, with electrodes urged into physical contact when the switch is in the ON state, and with mean surface proximity limited only by the combined mean asperity height of the electrodes and the thickness of their insulating layers. Numeral 505 in FIG. 5 identifies a vertical line representing gap between electrodes of one nanometer, and region 503 (represented by a dashed ellipse) represents a region of preferred operation, where conductivity is generally greater than 10⁶ Siemens/cm² (e.g., which exceeds the conductivity reached with high performance mechanical switches).

Thus, electrode with composite roughness sufficiently low to allow a substantial portion of their apparent contact surfaces to come within tunneling distance can achieve high conductivities with low to no contact force between apparent contact surfaces. This is effectively demonstrated using a simple model for conductivity vs. surface roughness/asperity height versus pressure. The surface area of the electrodes is divided into a grid significantly finer than the electrode asperities and other features such as pits and scratches, but significantly larger than tunneling electron wavelength. Given such a grid, and distance between electrode surfaces at each point in the grid, tunneling conductivity can be computed at each point via any appropriate WKB approximation-based method. In this regard, Simmon's “Generalized formula for the electric tunnel effect between similar electrodes separated by a thin insulating film” provides one such approximation. In this case the “thin insulating film” is a composite of any native insulator (e.g. oxide layer) on the electrode surfaces, and the switches insulating fluid (e.g. air). The distance between electrode surfaces at any point in the grid can be computed by standard finite element contact modeling techniques for the given electrodes. Alternatively, given asperities with significantly large radius to height aspect ratios, one can simply apply a linear elastic compression resistance matching the materials elastic modulus to each point in the grid. Such a grid for a given electrode can be supplied by a sufficiently precise profilometer or by atomic force microscopy.

As an example, conductivity versus pressure can be computed for a pair of chemical-mechanically-plararized nickel surfaces acting as electrodes. An atomic force microscope measurement of the surfaces show an average roughness (Ra) equal to approximately 0.35 nanometers, and supply us with the aforementioned grid. The nickel surface is cleaned such that effectively only its approximately 4 Angstrom thick native oxide layer is left behind. Computationally, the surfaces are then brought together to compute the contact force and tunneling conductivity. This data can then be compared with results from experiment.

These principles are represented by FIG. 6. FIG. 6 is a chart 601 that graphs conductivity as a function of contact force for 1 cm² chemically-mechanically-plararized nickel electrode surfaces of a tunneling switch, with those surfaces engaged and the switch in the ON state. A solid line curve represents conductivity. Unlike conventional mechanical switches, there is positive conductivity with zero-to-near-zero contact pressure, in this case approximately 2/cm² Siemens at zero Pascals pressure. A first dashed-line 603 denotes an asymptotic state where conductivity is completely independent of pressure. The conductivity represented by this asymptotic state is limited by the thickness of any native oxide layers. In connection with the data represented by FIG. 6, the depicted asymptote 603 is seen to be approximately 1300 Siemens/cm² for nickel. Contacts with thinner oxide layers have exponentially higher conductivities limits, e.g. contact conductivity>10² Siemens/cm² for chemically-mechanically-polished and dilute-hydrofluoric-acid-cleaned NiB.

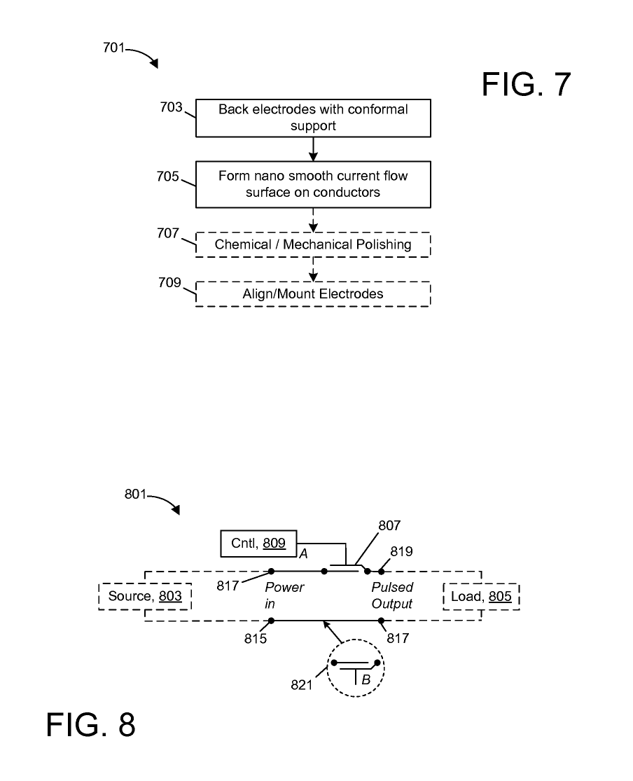

FIG. 7 illustrates a method associated with a tunneling switch, with the method being generally designated using reference numeral 701. One or both electrodes are first received, and backed with a conformal support or substrate, per numeral 703. Each electrode is then processed as appropriate to form a sufficient smooth surface, e.g., as indicated by numeral 705. As depicted by numeral 707, in one optional embodiment, this processing is achieved using a chemical-mechanical polishing process, as previously described. It is expected that such a process using conventional manufacturing techniques can result in apparent contact surfaces having asperities that are both small and gradual and, hence, that permit conformal contact over the substantial surface areas of the current-crossing surfaces, notwithstanding asperity presence. Again, use of a conformal support to mount one or both electrodes can facilitate such conformal contact. Note once again that each electrode current flow-through surface can advantageously have a low surface energy material, such that there is no cold welding or other process that causes the electrodes to stick together. Depending on application, electrodes are then aligned (709) and assembled together to form the switch. In one embodiment, electrodes are fabricated apart from one another and are manually assembled together. To this end, an optional alignment/mounting step can be performed to mount electrode current flow-through surfaces in a manner adapted for engagement and relative movement. Such a mounting step can be performed using a gluing, sintering or other process adapted to permanently fasten the electrodes to the piezoelectric or other actuator structure.

One general class of applications that can benefit from the tunneling switches described above relates to power conversion, particularly as used in high voltage power distribution systems. Such applications typically call for extremely high conductivity, high performance switches to limit thermal issues and loss. However, traditionally with such applications, rapid cycling of switch states, overload protection and other issues weigh heavily on systems design.

FIGS. 8-13B are used to exemplify certain power switching circuits, including pulse generators, AC-to-DC converters, DC-to-AC converters, DC and AC power control circuits and other circuits. These examples are illustrative only, and that the tunneling switches introduced above can be used in other applications as well.

FIG. 8 shows a pulse generation and/or power control circuit 801. The circuit generally is used to convert power supplied by a source 803 into a pulsed or continuous output that will be used to drive a load 805. Each of the source 803 and the load 805 are illustrated in dashed lines to indicate that they are optional, i.e., a pulsing circuit can be fabricated using one or more tunneling switches and sold for integration with a source and/or load, or for post-integration operation by a consumer. The tunneling switch is identified by graphic 807, with a control circuitry 809 generating an appropriate control signal (“A”) to open and close the tunneling switch 807 according to a desired duty cycle. For example, the source 803 can be a high voltage DC power source, the control signal can be a square wave pulse signal driven at a specific frequency and phase; a pulsed output of the circuit provided to the load can be a high-voltage pulsed signal timed according to the control signal A. In this case, DC power-in is coupled to the circuit via reciprocal nodes 815 and 817, and is processed to provide respective output DC power rails (e.g., +V and ground), at nodes 817 and 819. As indicated by optional component graphic 821, the circuit can also optionally include a second tunneling switch, such that both power rails are switched simultaneously; the second tunneling switch is seen driven by control signal “8,” which either can be connected to control signal A for simultaneous operation or can be separately driven. In one embodiment, for example, the load can be a DC motor driven according to the pulsed output of the pulse generation circuit 801.

FIG. 9A shows another example of a high-voltage switching circuit 901. In this case, it should be assumed that voltage-in (“Vᵢₙ”) arriving at node 903 will be gated and selectively delivered to an output node 915 as a voltage-out (“Vₒᵤₜ”). However, if the voltage to be gated exceeds the breakdown voltage of the tunneling switches, this potentially creates an issue where current can flow when the switching circuit 901 is in the OFF state. This issue is addressed for the circuit of FIG. 9 by spreading the voltage drop across a number of switches connected in series. For example, tunneling switches 905, 909, 911 and 913 are seen connected in series, with ellipses 907 generally denoting that any number of such switches can be connected in series as appropriate to the application. All such switches are seen as driven in common by control circuitry 917, via control signal A, such that all series switches are opened and closed together. For example, if 3000V is to be selectively connected from the input node 903 to the output node and a tunneling switch is used with a breakdown voltage of 600 V, then use of five or more such switches in series would result in a voltage drop across any one switch (ΔVᵢ) of no more than 600V. Note once again that tunneling switch design, including electrode materials, gap separation materials, gap size and other factors, can influence effective breakdown voltage. For example, as mentioned earlier, switch breakdown voltage can be dramatically increased by maintaining switches in a controlled atmosphere, e.g., to increase the effective breakdown voltage to 1000V-5000V or more.

FIG. 9B shows an alternate form of a series switch, generally designated using numeral 951. More specifically, FIG. 9B shows that a single switch assembly can be used to provide multiple series switches. Two substrates 953 and 955 each mount a series of electrodes, with the substrates being moved together and apart as described earlier to at-once open and close all of the series switches. This movement is represented by movement arrows 957. More specifically, the switch includes two terminals 959 and 961 for receiving respective voltage rails. On the first substrate 953, each electrode 963 is seen to be laterally separated by a gap 965 that is sufficiently large to prevent OFF state current flow between the electrodes. Similarly, on the second substrate 955, each electrode 967 is also seen to be laterally separated by a gap 969 that is sufficiently large to prevent OFF state current flow between these electrodes. Note further that electrodes 963 and 967 are seen laterally offset relative to one another. As the two substrates are moved together, to bring their respective electrodes' apparent contact surfaces to within tunneling distance, current flows between the offset electrode pairs as represented by current flow arrow 971. As should be appreciated, this arrangement provides for a series of switches to be operated together, and for use of the switch assembly 951 with a substantially higher voltage than could be used given the breakdown voltage implied by any one pair of electrodes from opposite substrates.

While some contemplated applications involve high-voltage switching, the tunneling switch presented by this disclosure can be used in lieu of or in addition to any type of switching application. As an example, hybrid switch devices are sometimes used for high voltage switching applications; where a low voltage switch is used to regulate a high-voltage switch to effectuate overload protection and/or very rapid, automatic switch control, a tunneling switch presented by this disclosure could be implemented as a high voltage switch, alone or in series or parallel with other switches, or as a low-voltage switch to help control switching by another form of mechanical or semiconductor switch. For example, such a hybrid switch and many of the power converters mentioned above are used as important switching components in a high-voltage DC (HVDC) distribution system, or in converting between HVDC and HVAC for purposes of power grid management. Again, many applications are possible.

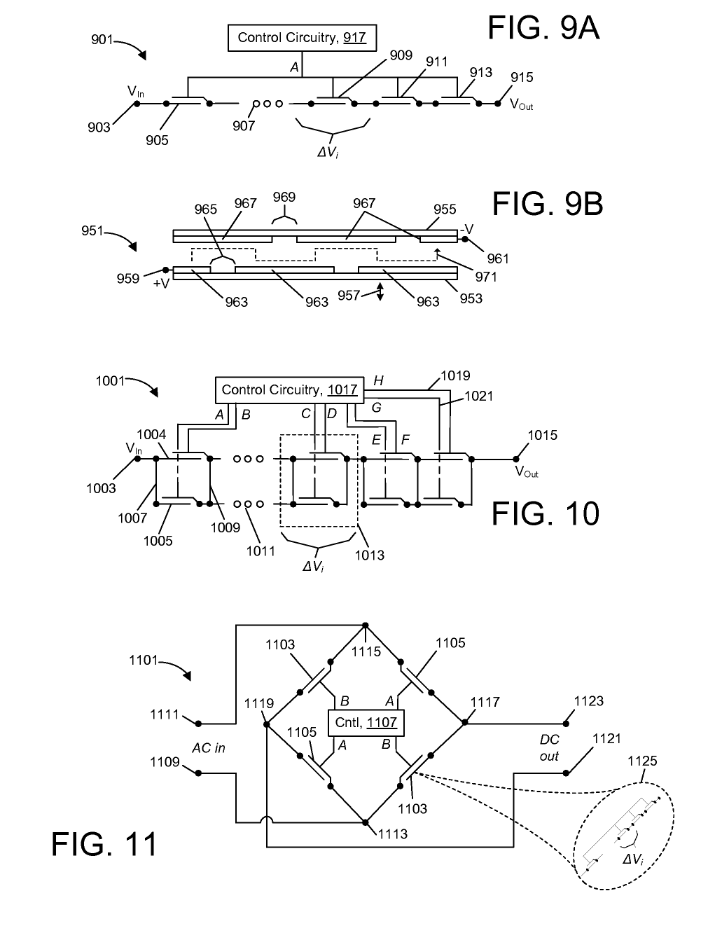

FIG. 10 shows a high-voltage switching circuit 1001 geared for high-availability applications. As with the design of FIG. 9A, it should be assumed that voltage-in (“Vᵢₙ”), arriving at node 1003, will be gated and selectively delivered to an output node 1015 as a voltage-out (“Vₒᵤₜ”). The design seen in FIG. 10 however puts every series switch, for example, switch 1004, in parallel with another tunneling (or non-tunneling) switch, for example, switch 1005. These switches are seen to have both their input nodes connected and both of their output nodes connected, as represented by connection paths 1007 and 1009, respectively. Each such pair of switches can be thought of as a switching cell that is to bear a portion (ΔVᵢ) of the overall voltage drop across the switching circuit 1001 when the switching circuit is in the open position. For example, such a cell is represented by dashed-line box 1013 in FIG. 10. Not that each switch in each cell optionally has a dedicated control signal, A-H; this permits selectively taking any particular switch offline while maintaining the switching circuit 1001 in a continuous ON state.

FIG. 11 shows another power conversion circuit, this time configured as an AC-to-DC power converter 1101 (e.g., as a full-wave rectifier). This design features four tunneling switches controlled as two pairs of switches, 1103 or 1105 respectively, under auspices of control circuitry 1107. AC power in is received via reciprocal nodes 1109 and 1111, and is provided to nodes 1113 and 1115 of the rectifier circuit. When AC voltage-in on node 1111 is positive and is to be provided to node 1115 of a DC output (and correspondingly when AC voltage-in on node 1109 is negative and is to be provided to node 1113 of the DC output), the control circuitry 1107 drives control signals A and B so as to open tunneling switches 1103 close the tunneling switches 1105. Conversely, when AC voltage-in on node 1109 is positive (and AC voltage-in on node 1111 is negative), the control circuitry 1107 drives control signals A and B so as to close tunneling switches 1105 and open tunneling switches 1103. With 60 hertz AC power for example, the control circuitry drives control signals A and B with a 50% duty cycle and opposite phase at 60 hertz. Note that the use of piezoelectrics (or electrostatic or magnetic, or other electronically controlled high frequency actuators) provides the benefits of conventional mechanical switch designs, but with very high operational speed and very high repeatability; avoiding excessive electrode contact force in such a design can also provide dramatic advantage in increasing switch service life, by avoiding electrode degradation that might be seen with high-contact force mechanical switches. As also noted by expansion graphic 1125, any one of or more of switches 1103/1105 can be replaced by a series or high availability arrangement (such as represented by FIGS. 9 and 10 respectively), if suited to the particular application.

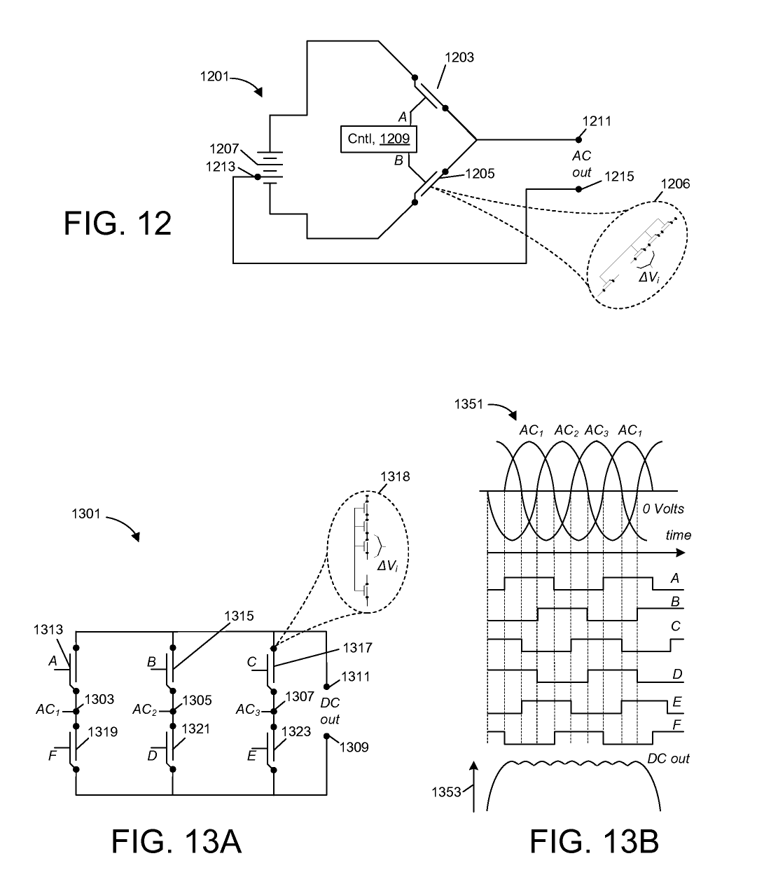

FIG. 12 shows yet another power conversion circuit 1201, this time configured as a DC-to-AC converter. This circuit uses two tunneling switches 1203 and 1205 (or again, a series or high-availability circuit, as represented by graphic 1206). A DC power source supplies power, as represented by a battery graphic 1207, with reciprocal terminals of this source each connected to a respective one of the tunneling switches 1203/1205. As with the circuit of FIG. 11, control circuitry 1209 generates reciprocal A/B control signals to alternate conduction between these two tunneling switches to provide a first AC power rail as output 1211. At the same time, the DC power source 1207 is center-tapped at node 1213 to provide a second AC power rail as output 1215. With adjustment for common mode between these states, the AC output is seen to present a differential signal where each of output nodes 1211 and 1215 swing between positive and negative voltages relative to its companion output node.

FIG. 13A shows a power conversion circuit 1301 adapted for three-phase AC-to-DC conversion. That is, the power conversion circuit 1301 receives three AC inputs “AC₁,” “AC₂” and “AC₃,” at respective nodes 1303, 1305 and 1307. As is conventional, each AC input has like-frequency of oscillation but is separated from the other AC inputs by 120 degrees of phase. The function of power conversion circuit 1301 is to deliver a pair of voltages at nodes 1309 and 1311 for use as DC power out. Accordingly, each of these AC inputs is provided to an input of a respective tunneling switch 1313, 1315 and 1317. Each tunneling switch 1313, 1315 and 1317 is, in turn, controlled according to a respective control signal A, B or C, also separated by 120 degrees of phase. Thus, as each AC input becomes positive, the associated tunneling switch 1313, 1315 or 1317 is moved to the ON state and used to supply power to output node 1307. As was the case earlier, any one or more of tunneling switches 1313, 1315 or 1317 can be replaced with a series tunneling switch or high-availability tunneling switch selection, as represented by graphic 1318. As implied with the circuits discussed previously, swings in AC input power can be automatically detected by controller circuitry and used to generate the appropriate control signal A, B or C. The control circuitry is omitted from FIG. 13A to simplify depiction, but typically is present with such a circuit.

Each of the three inputs AC₁, AC₂ and AC₃ is also connected to the second DC output node 1309, also via a respective tunneling switch 1319, 1321 and 1323. Each of these tunneling switches is also controlled according to a respective control signal E, D or E, each separated from each other by 120 degrees of phase. All six control signals represent a progression of 60 degrees of phase, for reason illustrated with reference to FIG. 13B. That is, FIG. 13B shows a voltage-time graph 1351 which illustrates the relationship between the three AC inputs AC₁, AC₂ and AC₃ and control signals A-F. For example, input AC₁ is positive for half of one period of the AC signal (equivalent to 180 degrees of phase), while inputs AC₂ and AC₃ are each positive/negative for two third/one third of this one-half period. Alternatively stated, exactly two AC inputs will be positive/negative at any instant in time while the other AC input is negative/positive. Appropriate 6-phase control over the respective switches permits power delivery to the appropriate DC node as appropriate from all three AC inputs. The circuit of FIG. 13 is also sometimes referred to as a bridge.

Notably, the power conversion circuit 1301 of FIG. 13 can also be used for reactive power control. That is, varying phase of all six control circuits together relative to the phases of the AC inputs provides different type of reactive switching capabilities. This type of control is useful for many types of different power delivery systems. The adjustment of this phase effectively varies DC output voltage, as denoted by amplitude arrows 1351 in FIG. 13B.

As shown by the description above, tunneling non-adhering switches (or relays) can advantageously replace semiconductor switches in high power and/or low duty cycle and/or low noise applications, and can advantageously replace mechanical switches in high switching frequency and/or long service life applications. In applications where efficiency and/or minimization of waste heat is important, tunneling non-adhering switches are good candidates to replace high power semiconductor devices such as thyristors, insulated-gate bipolar transistors (IGBTs/IGCTs), power diodes, and power metal oxide semiconductor field effect transistors (MOSFETS). Specific applications include, but are not limited to: electric current rectification and inversion, for example, us used in HVDC power transmission and wind and solar power generation; electric utility grid control electronics; traction motor control such as in electronic vehicles and trains; and electric marine motor control. Again, various other applications will occur to those skilled in the art.

The foregoing description and in the accompanying drawings, specific terminology and drawing symbols have been set forth to provide a thorough understanding of the disclosed embodiments. In some instances, the terminology and symbols may imply specific details that are not required to practice those embodiments. The terms “exemplary” and “embodiment” are used to express an example, not a preference or requirement.

As indicated, various modifications and changes may be made to the embodiments presented herein without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. An electric switch, comprising:
a first electrode having a first surface;
a second electrode having a second surface; and
a mechanism to move at least one of the first surface and the second surface between a first position and a second position to respectively open and close the electric switch;
where
the first surface and the second surface each have a mean asperity height,
the first position is characterized by a distance between the first surface and the second surface that is less than an electron tunneling length necessary for passage of current between the first surface and the second surface, notwithstanding the mean asperity height, between the substantial entirety of surfaces areas of each of the respective first and second surfaces; and
the second position is characterized by a minimum distance between the first surface and the second surface that is greater than the electron tunneling length.

2. The electric switch of claim 1, where:
the electric switch further comprises a chassis that operatively mounts each of the first electrode and the second electrode; and
the mechanism comprises a piezoelectric transducer that operatively couples the at least one to the chassis, the piezoelectric transducer operable to move the at least one between the first position and the second position to respectively open and close the switch.

3. The electric switch of claim 1, where:
first surface and the second surface each have an apparent contact surface through which current flows when the switch is closed; and
the apparent contact surfaces are maintained substantially parallel to one another, with the movement mechanism moving the at least one along an axis that is substantially normal to the regions.

4. The electric switch of claim 1, where at least one surface of the first surface and the second surface comprises a layer of high phosphorus electroless nickel (NiP).

5. The electric switch of claim 4, where each layer of NiP is formed on a conducting electrode, and is subsequently smoothed using a chemical mechanical planarization (CMP) process.

6. The electric switch of claim 1, where at least one surface of the first surface and the second surface comprises a layer of nickel boron (NiB).

7. The electric switch of claim 6, where each layer of NiB is formed on a conducting electrode, and is subsequently smoothed using a chemical mechanical planarization (CMP) process.

8. The electric switch of claim 1, where at least one surface of the first surface and the second surface comprises a semiconducting layer of amorphous carbon (a-C) formed on a conducting electrode.

9. The electric switch of claim 8, where each semiconducting layer is formed on a conducting electrode, and is subsequently smoothed using a chemical mechanical planarization (CMP) process.

10. The electric switch of claim 1, where at least one surface of the first surface and the second surface comprises a semiconducting layer of hydrogen terminated amorphous silicon (a-Si) formed on a conducting electrode.

11. The electric switch of claim 10, where each semiconducting layer is formed on a conducting electrode, and is subsequently smoothed using a chemical mechanical planarization (CMP) process.

12. The electric switch of claim 1, where at least one surface of the first surface and the second surface comprises a semiconducting layer of hydrogen terminated crystal silicon (c-Si) formed on a conducting electrode.

13. The electric switch of claim 12, where each semiconducting layer is formed on a conducting electrode, and is subsequently smoothed using a chemical mechanical planarization (CMP) process.

14. The electric switch of claim 1, where:
the electric switch further comprises a chassis that operatively mounts each of the first electrode and the second electrode; and
the mechanism comprises an electrostatic transducer that operatively couples the at least one to the chassis, the electrostatic transducer operable to move the at least one between the first position and the second position to respectively open and close the switch.

15. The electric switch of claim 1, where:
the electric switch further comprises a chassis that operatively mounts each of the first electrode and the second electrode; and
the mechanism comprises an electromagnetic transducer that operatively couples the at least one to the chassis, the electromagnetic transducer operable to move the at least one between the first position and the second position to respectively open and close the switch.

16. The electric switch of claim 1, where:
the electric switch further comprises a chassis that operatively mounts each of the first electrode and the second electrode; and
the mechanism comprises a mechanical transducer that operatively couples the at least one to the chassis, the electromagnetic transducer operable to move the at least one between the first position and the second position to respectively open and close the switch.

17. The electric switch of claim 1, where the electric switch comprises an enclosure that maintains a controlled environment between the first and second surfaces, the controlled environment including an insulator relative to air.

18. The electric switch of claim 16, wherein the controlled environment comprises dichlorodifluoromethane.

19. The electric switch of claim 16, wherein the controlled environment comprises sulfer hexafloride.

20. The electric switch of claim 16, where the first position and the controlled environment are characterized by a breakdown voltage between the first electrode and the second electrode of not less than five thousand volts.

21. The electric switch of claim 1, where the switch is characterized as having a current flow when in the second position that beyond an initial contact force is not primarily dependent on contact force between the first surface and the second surface once in contact.

22. In an electric switch having first and second electrodes that are brought relatively closer together in order to move the switch into a conductive state, and brought relatively farther apart in order to bring the electric switch into a non-conductive state, an improvement comprising:
employing for each of the first electrode and the second electrode a conductor surface each having a mean asperity height; and
employing a movement mechanism that physically moves at least one of the first surface or the second surface to move the electric switch between the conductive state and the non-conductive state in response to an electronic signal, the movement mechanism employing a throw to reduce gap between the conductor surface of the first electrode and the conductor surface of the second electrode to less than an electron tunneling length necessary for passage of current between the first surface and the second surface, such that current flows between the substantial entirety of surfaces areas of each of the respective first and second surfaces, notwithstanding the mean asperity heights, when the switch is in the conductive state, and to increase minimum gap between the conductor surface of the first electrode and the conductor surface of the second electrode to be greater than the electron tunneling length when the switch is in the non-conductive state.

23. The improvement of claim 22, where the conductive state is characterized by a current flow that is not primarily dependent on contact force at points of contact between a conductive surface of the first electrode and a conductive surface of the second electrode once those conductive surfaces are in contact.

24. A power control device, comprising:
at least two switches, each switch including a first electrode having a first surface, a second electrode having a second surface, and a mechanism to move at least one of the first surface and the second surface between a first position and a second position to respectively open and close the electric switch, where the first surface and the second surface each have a mean asperity height, the first position characterized by a distance between the first surface and the second surface that is less than an electron tunneling length necessary for passage of current between the first surface and the second surface, such that current flows between the substantial entirety of surfaces areas of each of the respective first and second surfaces, notwithstanding the mean asperity heights, and the second position characterized by a minimum distance between the first surface and the second surface that is greater than the electron tunneling length; and
circuitry to control the mechanism for each switch to move each switch between the respective first and second positions at related times.

25. The power control device of claim 24, where:
each switch further comprises a chassis that operatively mounts each of the first electrode and the second electrode; and
the mechanism for each switch comprises a transducer that operatively couples the at least one to the chassis, the transducer operable to move the at least one between the first position and the second position to respectively open and close the respective switch.

26. The power control device of claim 24, where for each switch:
first surface and the second surface each have a region through which current flows when the switch is closed; and
the regions are maintained substantially parallel to one another, with the movement mechanism moving the at least one along an axis that is normal to the regions.

27. The power control device of claim 24, where for each switch at least one surface of the first surface and the second surface comprises a layer of at least one of high phosphorus electroless nickel (NiP), nickel boron (NiB), semiconducting diamond-like carbon, semiconducting amorphous silicon, hydrogen terminated amorphous silicon, or hydrogen terminated crystal silicon.

28. The power control device of claim 27, where each layer is formed on a conducting electrode, and is subsequently smoothed using a chemical mechanical planarization (CMP) process.

29. The power control device of claim 24, where each electric switch comprises an enclosure that maintains a controlled environment between the first and second surfaces, the controlled environment including an insulator relative to air.

30. The power control device of claim 29, wherein the controlled environment for each switch comprises dichlorodifluoromethane.

31. The power control device of claim 29, where for each switch, the first position and the controlled environment are characterized by a breakdown voltage between the first electrode and the second electrode of not less than three thousand volts.

32. The power control device of claim 24, where each switch is characterized as have a current flow when in the second position that is not primarily dependent on contact force at points of contact between the first surface and the second surface once in contact.

33. The power control device of claim 24, embodied as an AC to DC power converter, where:
a first switch of the at least two switches and a second switch of the at least two switches are assigned to respective AC power phases; and
the circuitry is to generate a control signal respective to each of the first switch and the second switch, to close the respective switch during at respective intervals of time.

34. The power control device of claim 33, where:
the power converter comprises input nodes for each of three AC power phases;
the at least two switches further comprises a third switch, each of the first switch, the second switch and the third switch assigned to a respective one of the three AC power phases;
the circuitry is to generate a control signal respective to the third switch to close the third switch during a respective interval of time; and
the control signal respective to each of the first switch, the second switch and the third switches comprises a pulsed signal of like-frequency, but incrementally offset by approximately one-hundred-and-twenty degrees in phase.

35. The power control device of claim 33, where:
the at least two switches further comprises a fourth switch, a fifth switch and a sixth switch, each of the fourth switch, the fifth switch and the sixth switch assigned to a respective one of the three AC power phases;
the circuitry is to generate a control signal respective to each of the fourth switch, the fifth switch and the sixth switch to close the respective fourth switch, fifth switch or sixth switch during a respective interval of time; and
the control signal respective to each of the first switch, the sixth switch, the second switch, the fourth switch, the third switch and the fifth switch comprises a pulsed signal of like-frequency, but incrementally offset by approximately sixty degrees in phase.

36. The power control device of claim 34, embodied as a rectifier, where:
a first switch of the at least two switches and a second switch of the at least two switches are assigned to respective AC voltage rails; and
the circuitry is to generate a control signal respective to each of the first switch and the second switch, to close the respective switch during respective intervals of time.
